(19) United States
(12) Patent Application Publication
(10) Pub. No.: US 2009/0024590 A1
(43) Pub. Date: Jan. 22, 2009

(54) USER CONTRIBUTED KNOWLEDGE DATABASE

(76) Inventors: Timothy STURGE, San Francisco, CA (US); Kurt Bollacker, San Francisco, CA (US); Robert Cook, Berkeley, CA (US); John Giannandrea, Saratoga, CA (US); Nicholas Thompson, San Francisco, CA (US); Edwin Taylor, Fairfax, CA (US)

Correspondence Address: GLENN PATENT GROUP, 3475 EDISON WAY, SUITE L, MENLO PARK, CA, 94025, US

(21) Appl. No.: 12/049,145

(22) Filed: Apr. 22, 2008

Related U.S. Application Data
(60) Provisional application No. 60/918,584, filed on Mar. 15, 2007.

(51) Int. Cl. G06F 7/06; G06F 17/30

(52) U.S. Cl. 707/3; 707/103 R; 707/102; 707/E17.055; 707/E17.014

(57) ABSTRACT

A large open database of information has entries for commonly understood data, such as people, places and objects, which are referred to as topics. The database has a type system and contains attributes and relationships between topics. The invention also comprises a powerful query language and an open API to access the data and a website where contributors can update the data or add new topics and relationships. The elements of the invention comprise a scalable graph database, a dynamic user contributed schema representation, a tree-based object/property query language, a series of new Web service APIs, and set of AJAX dynamic HTML technologies.

### CROSS REFERENCE TO RELATED APPLICATIONS

This application claims priority to U.S. Provisional Application Ser. No. 60/918,584 filed Mar. 15, 2007, which application is incorporated herein in its entirety by this reference thereto.

### BACKGROUND OF THE INVENTION

1. Technical Field

The invention relates to the organization and use of information. More particularly, the invention relates to a scalable graph database.

2. Description of the Prior Art

There is widespread agreement that the amount of knowledge in the world is growing so fast that even experts have trouble keeping up. Today not even the most highly trained professionals—in areas as diverse as science, medicine, law, and engineering—can hope to have more than a general overview of what is known. They spend a large percentage of their time keeping up on the latest information, and often specialize in highly narrow sub-fields because they find it impossible to keep track of broader developments.

Education traditionally meant the acquisition of the knowledge people needed for their working lives. Today, however, a college education can only provide an overview of knowledge in a specialized area, and a set of skills for learning new things as the need arises. Professionals need new tools that allow them to access new knowledge as they need it.

### The World Wide Web

In spite of this explosion of knowledge, mechanisms for distributing it have remained pretty much the same for centuries: personal communication, schools, journals, and books. The World Wide Web is the one major new element in the landscape. It has fundamentally changed how knowledge is shared, and has given us a hint of what is possible. Its most important attribute is that it is accessible—it has made it possible for people to not only learn from materials that have now been made available to them, but also to easily contribute to the knowledge of the world in their turn. As a result, the Web's chief feature now is people exuberantly sharing their knowledge.

The Web also affords a new form of communication. Those who grew up with hypertext, or have otherwise become accustomed to it, find the linear arrangement of textbooks and articles confining and inconvenient. In this respect, the Web is clearly better than conventional text.

The Web, however, is lacking in many respects.

It has no mechanism for the vetting of knowledge. There is a lot of information on the Web, but very little guidance as to what is useful or even correct.

There are no good mechanisms for organizing the knowledge in a manner that helps users find the right information for them at any time. Access to the (often inconsistent or incorrect) knowledge on the Web thus is often through search engines, which are all fundamentally based on key word or vocabulary techniques. The documents found by a search engine are likely to be irrelevant, redundant, and often just plain wrong.

The Web knows very little about the user (except maybe a credit card number). It has no model of how the user learns, or what he does and does not know—or, for that matter, what it does and does not know.

### A Comparison of Knowledge Sources

There are several aspects to how learners obtain knowledge—they might look at how authoritative the source is, for example, or how recent the information is, or they might want the ability to ask the author a question or to post a comment. Those with knowledge to share might prefer a simple way to publish that knowledge, or they might seek out a well-known publisher to maintain their authority.

While books and journals offer the authority that comes with editors and reviewers, as well as the permanence of a durable product, the Web and newsgroups provide immediacy and currency, as well as the ability to publish without the bother of an editorial process. Table “A” is a summary of the affordances of various forms of publishing.

TABLE A
Affordances of Various Forms of Publishing

| | | NEWS | TEXT | |
|---|---|---|---|---|
| | THE WEB | GROUPS | BOOKS | JOURNALS |
| Peer-to-Peer | Yes | Yes | No | Limited |
| publishing | | | | |
| Supports | Yes | Limited | No | Limited |
| linking | | | | |
| Ability to add | No | Yes | No | No |
| annotations | | | | |
| Vetting and | No | Limited | Yes | Yes |
| certification | | | | |
| Supports | Limited | No | Yes | Yes |
| payment model | | | | |
| Supports | Limited | No | Yes | No |
| guided learning | | | | |

### Corporate and Government Needs

For institutions, corporations, and governments, failure to keep track of knowledge has consequences that are quite different from those for an individual. Often, institutions make a bad decision due to lack of knowledge on the part of those at the right place and at the right time, even though someone else within the institution may actually hold the relevant knowledge.

Similarly, within a corporation, the process of filtering and abstracting knowledge as it moves through the hierarchy often leaves the decision-maker (whether the CEO, the design engineer, or the corporate lawyer) in a position of deciding without the benefit of the best information. The institutional problem is made worse by the problem of higher employee turnover in the more fluid job market, so that the traditional depository of knowledge—long-standing employees—is beginning to evaporate, just as the amount of knowledge that needs to be kept track of is exploding.

The consequences of not having the right knowledge at the right place and time can be very severe: doctors prescribing treatments that are sub-optimal, engineers designing products without the benefit of the latest technical ideas, business executives making incorrect strategic decisions, lawyers making decisions without knowledge of relevant precedents or laws, and scientists working diligently to rediscover things that are already known—all these carry tremendous costs to society.

The invention addresses the problem of providing a system that has a very large, e.g. multi-gigabyte, database of knowledge to a very large number of diverse users, which include both human beings and automated processes. There are many aspects of this problem that are significant challenges. Managing a very large database is one of them. Connecting related data objects is another. Providing a mechanism for creating and retrieving metadata about a data object is a third.

In the past, various approaches have been used to solve different parts of this problem. The World Wide Web, for example, is an attempt to provide a very large database to a very large number of users. However, it fails to provide reliability or data security, and provides only a limited amount of metadata, and only in some cases. Large relational database systems tackle the problem of reliability and security very well, but are lacking in the ability to support diverse data and diverse users, as well as in metadata support.

The ideal system should permit the diverse databases that exist today to continue to function, while supporting the development of new data. It should permit a large, diverse set of users to access this data, and to annotate it and otherwise add to it through various types of metadata. Users should be able to obtain a view of the data that is complete, comprehensive, valid, and enhanced based on the metadata.

The system should support data integrity, redundancy, availability, scalability, ease of use, personalization, feedback, controlled access, and multiple data formats. The system must accommodate diverse data and diverse metadata, in addition to diverse user types. The access control system must be sufficiently flexible to give different users access to different portions of the database, with distributed management of the access control. Flexible administration must allow portions of the database to be maintained independently, and must allow for new features to added to the system as it grows.

It would be advantageous to provide a system to organize knowledge in such a way that users can find it, learn from it, and add to it as needed.

### SUMMARY OF THE INVENTION

The preferred embodiment of the invention comprises a large open database of information that is distinguished, in part, from the state of the art by having entries for commonly understood data, such as people, places and objects, which are referred to herein as topics. For example the inventive database contains separate entries for Los Angeles, Calif., Morgan Freeman, and Academy Award for Best Supporting Actor, and can store the relationship between these topics. There are over three million topics in the initial version of the inventive database and over 100 million relationships between the various items in the database.

The database has a type system and contains attributes and relationships between topics. So for example, Morgan Freeman is typed as a Film Actor, as a Person, and as a person he has an attribute called Birth date. The inventive database is intended to be used, and contributed to, by a wide community of users. There is a powerful query language and an open API to access the data and a website where contributors can update the data or add new topics and relationships.

The invention comprises, inter alia, a database, it is not an ontology. While it attempts to capture the relationships between a large number of topics, it does not contain a set of formal definitions or assertions about those topics. Unlike OWL, for example, the inventive database does not provide a mechanism to assert disjunction or transitivity. Unlike Cyc, the inventive database does not provide a reasoning engine.

The invention comprises an open database, and its goal is to allow relationships between as many topics as possible. Everything in the inventive database is openly available and so this limits it to storing information that may be linked to by other information on the Web. This means that the inventive database is not a good place to store private or fast changing information.

There are five major technologies in the presently preferred embodiment of the invention:
A scalable graph database;
A dynamic user contributed schema representation;
A tree-based object/property query language;
A series of new Web service APIs; and
A set of AJAX dynamic HTML technologies.

A brief summary of each are provided here with links to extended documentation of the public APIs.

### Graph Database

The core of the inventive database is a new implementation of a graph database. A large number of application domains model information whose logical structure is a graph and which emphasize dynamic interconnectivity between the data. These applications are not well served by relational databases. Graph databases have been in use for many decades and have recently seen an increase in popularity with the RDF based Semantic Web project.

The graph store in this embodiment of the invention emphasizes scalability, performance, and correctness in the face of community built application demands. It is also freely available as a service on the World Wide Web so that any application can use the database as part of its infrastructure, much like the domain name system is a database used by Web applications.

Objects in the database store are referred to as primitives. All primitives are versioned and attributed to database contributors. Relationships between primitives are implicitly bi-directional.

### Dynamic Schema

All databases present an API and basic type system to its users. The type system in the preferred embodiment of the invention is created by the users of the database and is stored in the graph itself. A small number of inherent types are provided and all the application types are built on top, such as Company and Disease. A unique feature of the invention is that the community of users creates the types that are then instantly available via the query API, so that schema building is not a separate activity from data entry. Existing relationships in the graph continue to function as schemas are expanded, making the schemas accretive, rather than versioned.

The preferred embodiment of the invention has a namespace model which is built on the core type system, with names such as ‘/music/genre/artists’ being resolved against the dataset rather than being pre-declared. The preferred embodiment also has an access control and permissions model which is built on the graph, and which allows permissions to be devolved to groups of database contributors easily.

### Query Language

The inventive database is accessed via a query language referred to as MQL. This query language provides a simple but powerful syntax for making graph queries which are informed by the dynamically generated schemas, for example: query the birth date and all films of an actor whose name and one film is known. MQL presents an object and property based interface to the graph database which is more accessible and easy to use than existing graph query languages. MQL uses a notion of query trees which are expanded by the system to yield query results. A hierarchical query representing a graph constraint is sent to the service which replies with a similarly shaped tree containing the results. The API for writing to the database uses a similar tree based model.

The query language supports explicitly ordering items, sorting result sets, optional constraint clauses, and highly nested queries. The present embodiment of MQL is based on the JSON open standard data interchange syntax which is particularly easy for Web developers to use in their applications.

### Public APIs

The inventive database is accessed via the Web using a number of open standard REST APIs. To access the database an application only needs to support HTTP and JSON open standard protocols. The APIs include services for authentication, database query and update, requesting large objects of various media types, and performing search functions including auto-complete. These APIs are intended to be stable and long lived so that developers can use these Web services directly in their own applications.

### AJAX Components

The database website is built using a framework of AJAX dynamic HTML components. These components are freely available for developers to re-use in their own applications. The components help provide user interface elements, not just for large scale collaborative editing of the database, but for user input of compound values including dates, auto-completing lists, and image views. While the public APIs can be used with any application framework that understands JSON and HTTP, it is thought that these components help make it easier to build database derived applications with advanced functionality. Notably, the following features of the invention are considered to provide a significant advance in the state of the art:

### Open Database

The invention provides a large singe database of topics, cross referenced; and collaborative reconciliation and relating of schema and instances.

### Object Model

The invention provides a dynamic schema.

The type system provides familiar object->property schemas, which are implemented in the graph store as data.

Another unique feature of the invention is that the community of users create the types that are then instantly available via the query API, so that schema building is not a separate activity from data entry. Existing relationships in the graph continue to function as schemas are expanded, making the schemas accretive, rather than versioned.

Topics can be multiply typed and properties are optional. Type hinting is provided rather than inheritance.

The invention also provides for collaborative schema development.

### Permission System

A permission system is implemented via data structures in the graph related to properties, user groups, and groups of users.

The access system takes advantage of the directional nature of the property mechanism.

### Namespaces

A namespace system is implemented via data structures in the graph; e.g. ‘/’ is a primitive with ‘has_key’ of ‘film’ which results in the path ‘/film/’ etc.

### Query Language

The invention further comprises a query language (MQL) that uses a notion of query trees which are expanded by the system to yield query results. A hierarchical query representing a graph constraint is sent to the service which replies with a similarly shaped tree containing the results. Thus, this aspect of the invention comprises:
hierarchical result structure from a graph; and
query structure same as result structure.

The query language supports explicitly ordering items, sorting result sets, optional clauses, and highly nested queries. The presently preferred embodiment of MQL is based on the open-source JSON representation syntax which is particularly easy for Web developers to use in their applications. Thus, this aspect of the invention comprises:
use of JSON as a database query language; and
use of JSON to represent a graph hierarchically.

The invention comprises a similar tree-based write syntax including deep tree writes, unless it exists as a write operator.

### User Interface Elements

The preferred embodiment provides typed autocomplete of list items.

### Graph Database Implementation

Objects in the database store are referred to as primitives. All primitives are versioned and attributed to contributors. Relationships between primitives are inherently bi-directional. Thus, this aspect of the invention comprises:
Details of graph primitives as a triple store;
Use of links to store literals;
Links to Links; and
Primitive versioning.

### BRIEF DESCRIPTION OF THE DRAWINGS

FIG. 1 is screen shot of a sample page showing the browsing of knowledge at metaweb.com according to the invention;

FIG. 2 is a screen shot of a Web application enabled with various novel features according to the invention;

FIG. 3 is a schematic diagram showing nodes and relationships according to the invention;

FIG. 4 is a tree diagram showing categories of types according to the invention;

FIG. 5 is a screen shot showing types for all domains according to the invention;

FIGS. 6a and 6b are screen shots showing a film filter for types according to the invention;

FIGS. 7a and 7b are screen shots showing user created properties for a film filter type according to the invention; and

FIG. 8 is a screen shot showing an explore view for the user created properties for a film filter type of FIG. 7, according to the invention.

### DETAILED DESCRIPTION OF THE INVENTION

The presently preferred embodiment of the invention comprises a vast open online repository of structured knowledge. Users can access and contribute to an inventive database at a website, e.g. http://www.metaweb.com/metaweb/, or through an API described below. In a presently preferred embodiment, the inventive database is seeded with detailed information about popular music and movies.

### Overview

The invention comprises all of a database, the data itself, a Web service, browser-based Web clients, and other Web client applications. The database is a graph database that provides a way to store free-form data. In the invention, the graph database provides for flexible representation, limited central planning, and is similar in some respects to the semantic Web.

The invention also includes a further database, which is referred to as the blob database. For purposes of the discussion herein, traditional flat files are stored as blobs. These items are articles, images, sound bites, and the like. They may be thought of as the leaves of the graph in the graph database. Metadata are stored in the graph, but the blobs are immutable. Some indexing is done on text blobs but, most commonly, a blob is found using the graph database. The database in the invention is seeded with many useful topics, referred to as the data. These topics may be such things as Wikipedia topics, articles, images, music, film, books, television, countries, cities, places, people, corporations, agencies, soft drinks, stamp collections, medical conditions, and anything else that people want to talk about. With regard to data in the graph database, the low-level data model used in the invention is similar to RDF, although the client is shielded from this.

In the graph there are many nodes and many links. A link connects a pair of concept instances, left and right. A link has both a direction and a link type and a link type is itself a node. The invention also includes a query language that builds on the raw graph database to provide several facilities. User APIs provide a browser-friendly data representation (JSON), and an object-oriented view of the data using types, namespaces and namespace paths, access control, and ordered and partially ordered collections.

An example of a query using the query language of the invention is as follows:

```
{
    “name”: “Buster Keaton”,
    “id”: null,
    “type”: “/film/actor”,
    “film”: [{
        “film”: {
            “id”: null,
            “name”: null,
            “initial_release_date”: null
        }
    }]
}
```

An example of a response to a query is as follows:

```
{
    “id”: “#9202a8c04000641f8000000000056600”,
    “name”: “Buster Keaton”,
    “film”: [
        {
            “type”: “/film/performance”,
            “film”: {
                “id”:
“#9202a8c04000641f800000000008910a”,
                “name”: “Sherlock, Jr.”,
                “initial_release_date”: “1924-04-21”
            }
        }, {
            “type”: “/film/performance”,
            “film”: {
                “id”:
“#9202a8c04000641f80000000002c39db”,
                “name”: “Steamboat Bill Jr.”,
                “initial_release_date”: “1928-05-19”
            }
        }]
}
```

Unique to the invention are types, which provide classification of concept instances. A concept may be an instance of more than one type. In the invention, all typing is explicit. There is almost no subtyping. Each type has exactly one schema in the present embodiment of the invention.
Co-typing refers to the fact that many objects have multiple types. For example, Arnold Schwartzenegger is a person, a bodybuilder, an actor, and a politician. If it is necessary to refer to properties from multiple schemas one must use fully qualified property names, such as:

```
{
    “/common/person/birth_date”: “1935-10-30”
    “/film/actor/films”: [...]
}
```

In the invention, a schema maps between small subgraphs and objects. Each type has exactly one schema. Schema is analogous to the object/relational mapping provided by some relational database clients. Globally, the invention provides a graph, but locally it is preferable to look at objects. In the invention, a schema contains a list of named properties. A property maps a text key to a link type, within the context of the particular type. Thus, it is possible to use the same property name in different schemas. A property may have an expected type (at most one). The expected type may have a reverse property (at most one). The potential reversibility of all links is one of the things that makes the graph database in the invention uniquely powerful.

Another novel aspect of the invention is that almost all the properties can be multi-valued. In the invention, a schema may constrain some properties to be unique. This provides a convenient syntax for updating unique values in-place. In the invention, multi-valued properties are transferred as JSON arrays, although the arrays are not themselves values.

The invention also includes the notion of a namespace, which is a collection of key/value pairs. Each namespace may contain at most one value for a particular key. This leads to the uniqueness property of namespace paths, which allows them to be used as ids. Any object may be referenced from multiple namespaces. Namespaces do not form a strict tree. This allows aliases. Objects within the database that are sufficiently important have a type referred to as /common/topic. Examples of this type include descriptions and nicknames and properties for articles and images. Most objects that are interesting to humans are topics, e.g. “Buster Keaton” or “Sherlock Jr.” Non-topic objects usually glue topics together, e.g. “Buster Keaton's performance in Sherlock, Jr.” Objects may be promoted to topics as needed.

Graph stores that have been built before have nodes that are connected together, where the nodes are fully connected graphs and do not have to be a tree. For example, one of the nodes might be Arnold Schwarzenegger is married to Maria Shriver. The nodes represent concepts in the real world and the link between them represents a semantic relationship. Here, link is “married to.” By connecting Arnold Schwarzenegger, is married to, and Maria Shriver a triple is formed that provides a core way to represent knowledge. Such triples are well known. One problem is that when knowledge is represented this way, it is difficult to query it in an object-oriented program.

In the invention, when one writes a query one finds things by name. Thus, the invention concerns finding a small subset that meets all the constraints of the query based on identity, rather than as a result of combining things, i.e. by a join.

The invention thus finds a subset of all the things inside the graph, where the graph comprises virtually hundreds of millions of things. For example, if the query is for a spouse, e.g. finding any person named Arnold whose spouse was born in Moscow, the user gets an answer back quickly. Accordingly, the preferred embodiment of the invention provides a large graph of knowledge representation. All links in the graph are stored as triples. Thus, all links have a left node, a right node, and a type. The format of data in that graph is novel, as are the taxonomy and the organization. The query language is also novel, and the query language works against whatever it's in the graph. In the foregoing example, there are spouses and people named Arnold, but if these things were not in the graph these queries would not work.

What makes this all work in the invention is an inventive type schema. The core database does not understand such things are types. The core database is only concerned with triples. Further, the core database has an API which is not exposed publicly. The user merely loads the database with the user's sets and the database figures out how to return appropriate subsets to the user. Thus, the database itself represents the schema.

There is an object in the database referred to as a type, for example a person type, and a property of the type, for example a person type referred to as a spouse. There can also be one or more other properties, such as place of birth. The representation of these things is accomplished using the same mechanisms that are used to store the data itself. Thus, in the same way the that “Arnold was born in Austria” is stored in the graph, “Austria” and “Moscow” as places are also stored. Objects are also bidirectional. Thus, a property such as “place of birth,” can have another property associated with it, e.g. “person,” and “city/town” can have a property called “people born in.” Each property is linked to other properties such that it is bidirectional. In this regard, a triple is a single link between two things. There is a link type and the ends of the link. Thus, the link is attached to a property. It is therefore possible to tell from the properties which constraint to use. So, “place of birth” can be treated in an object-oriented way, but the invention returns an answer from the graph, i.e. the database.

Key to the novel query language is the schema mechanism described above. With the invention, however, it is possible to create a graph independently. It is straightforward to build a graph system that stores triples and build up a database of hundreds of millions triples quickly. However, a problem arises when trying to query the triples to get a subset fast. One way that this is accomplished in the presently preferred embodiment of the invention is to organize the terms associated with the links into properties which are grouped by type, such that the relations between the nodes, as expressed by the links therebetween, are types. These relationships are assertions of fact that comprise actual data in the database and that are grouped by property into a class of related things. Uniquely in the invention, the properties map directly to the three components of the triple, i.e. the link and the things at the end of the link, resulting in a mapping between the components of the triple and the type system.

The novel query language of the invention is made possible by the object model. The graph does not know anything about the type system at all. It only knows about the links. The type system is built using these links. For example, instead of creating a thing called “Arnold Schwarzenegger,” the invention creates a thing called property. The schema concerns properties, such as city/town, while the data concerns a thing having that property, such as Menlo Park. Thus, the schema is implemented in the graph, as well as the instance data. Thus, the connections between nodes are objects in and of themselves. Accordingly, the query language allows meta queries. For example, consider the instance Arnold Schwarzenegger. A query may ask the system what kind of types he has. Instead of responding with everything known about Arnold Schwarzenegger, the system responds with everything meta known about him, e.g. he's a person. Thus, the query language allows the user to know which types Arnold is, e.g. a person, a politician, a film star, and an athlete. That's four different kinds of things. The user can then query the system to respond about Arnold Schwarzenegger as a politician, and the user would get a voting record and offices held. Thus, a distinction is made between types, such as politician and properties, such as spouse and Austrian. Properties are the links, i.e. assertions about something always have a property. Thus, the middle term in a triple always has a related property somewhere. However, properties are grouped up into types, e.g. things that are expected of a company, of a restaurant, or of a digital camera. An instance is not expected to have those properties unless its of that kind. In the invention, there is a special link which says that an instance is of that kind, e.g. there is a link which says that Arnold Schwarzenegger is an instance of a person. Thus, a type has one or more associated properties. It is an assertion of a fact. The triples are the knowledge base. The invention uses an assertion of fact to find the properties, e.g. of a person to make it as though he's an object called person. If a type has too many properties, then the type may spawn further types. For example a person can have many properties, but being an actor or actress does not go into the person type, it becomes its own type because most people are not actors. In the invention. there is not an explicit type hierarchy. In other words, there's no inheritance. Rather, it is a very flat system because the assertion of type inclusion is an assertion of fact in the database itself. Thus, knowing that Arnold is an actor is, in and of itself, a piece of information, even if the type system is not used. The type is used to collect up all properties of an instance. In the preferred embodiment, the properties are contributed by users. The user community is able to edit the schema and add properties, which then show up to other people who are querying the system. Thus, the invention provides end-user schema editing.

As discussed above, the invention comprises, inter alia, a database, the data in the database, and a Web service for building an application on top of the database. The core database is this graph database that comprises a triple store. There is also another store that comprises a database of large files, such as images, large chunks of text, and so on that are not stored in the graph database. These items are stored in a separate, content database. There is a pointer in the graph database that points to the content in this separate database. The database contains many nodes and links. Links have a left node, a right node, and a direction, i.e. left to right or right to left. The link type itself is a node. Thus, the type is also a node in the graph and link types are also data in the database. Thus, while the links themselves are not nodes, the type of a link is a node. As a result, it is possible to query the links. The query language builds on the database to provide a browser-friendly data representation, i.e. an object-oriented view of the data using the types.

### The Query API

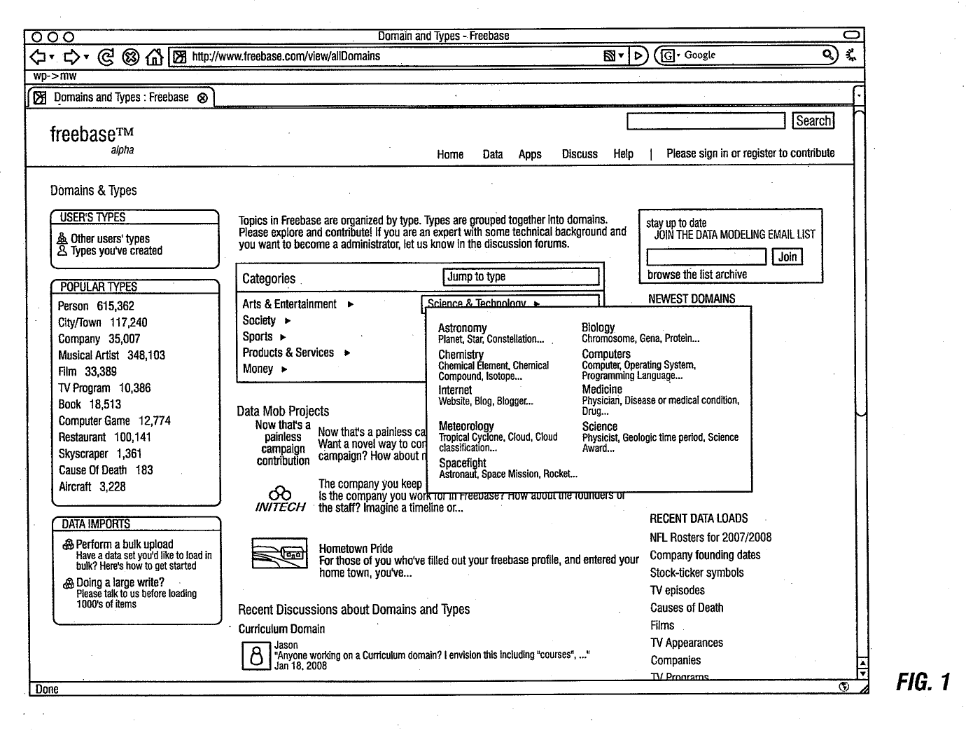

FIG. 1 is screen shot of a sample page showing the browsing of knowledge at a website, e.g. metaweb.com, according to the invention. The preferred embodiment of the invention offers a powerful API for making programmatic queries. This allows a user to incorporate knowledge from the inventive database into the user's applications and websites. For example, if a user types the following URL into his Web browser's location bar:
http://www.metaweb.com/mw/service/mqlread?query=\{“type”:“/music/artist”,“name”:“The Police”,“album”:[ ]}

There are a lot of braces, quote marks, colons, and commas in that URL, but remember that this is a programmatic API: the query is supposed to be generated by a computer, not pecked out by human fingers.

Translated into English, this query says:
Find an object in the database whose type is “/music/artist” and whose name is The Police. Then return its array of albums.

If the user got all of the punctuation correct, a database server responds to this query with a response of MIME type application/json. The response is plain text, but the user's browser probably does not display it to. Instead, the browser allows the user to save it to a file, which he can then view from the command line or with any text editor. When the user views it, he sees something like this:

```
{
  “status”: “200 OK”,
  “query”: {
    “album”: [ ],
    “type”: “/music/artist”,
    “name”: “The Police”
  },
  “messages”: [ ],
  “result”: {
    “album”: [
      “Outlandos d'Amour”,
      “Reggatta de Blanc”,
      “Live in Boston”,
      “Zenyatta Mondatta”,
      “Ghost in the Machine”,
      “Synchronicity”,
    ],
    “type”: “/music/artist”,
    “name”: “The Police”
  }
}
```

The response has the same braces and quotes that the query did: they provide the structure that makes this response easy to parse for a computer. This response begins with an HTTP status code. It repeats the query made, and then provides the response to the query. The example query included the text:
“album”:[ ]

In the response, the empty square brackets have been filled in with a long list of album names. For brevity, several live and compilation albums were omitted from the list shown above.

### System-Enabled Web Applications

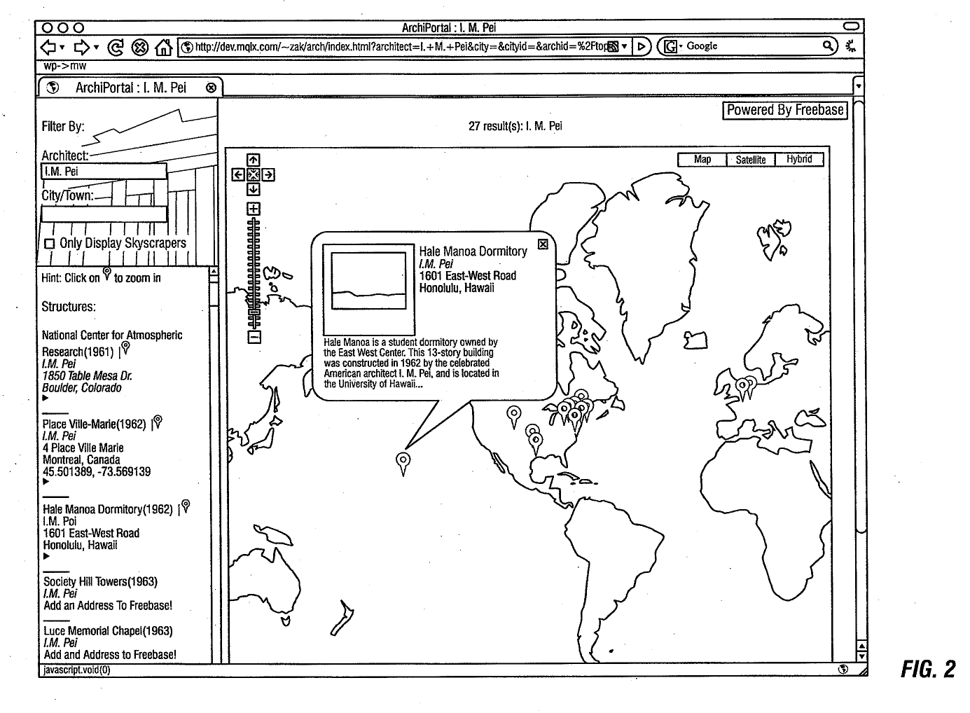

Making queries from a Web browser's location bar is interesting, but it becomes more interesting if we make the queries under programmatic control. Imagine that a script running on a Web server handles the communication with inventive database. One might write a simple Web application, such as that pictured in FIG. 2, which is a screen shot of a Web application enabled with various novel features according to the invention. This album-listing web application was created with the simple PHP code listed below in Table 1.

TABLE 1
PHP Code for Querying the Inventive Database

<head><title>Albums by <?=$_GET[“band”]?></title></head>
<body>
<h1>Albums by <?=$_GET[“band”]?></h1>
<?php
// What band are we interested in?
$band = $_GET[“band”];
// Compose a Metaweb query for albums by the specified band
$query = ‘{“name”:“‘.$band.’”,“type”:“/music/artist”,“album”:[ ]}’;
// Encode it for use in a URL
$encoded_query = urlencode($query);
// This is the complete URL for the query
$url = “http://www.metaweb.com/mw/service/mqlread?query=”
$encoded_query;
// Use the curl library to send the query and get response text in $data
$s = curl_init($url);
curl_setopt($s, CURLOPT_RETURNTRANSFER, TRUE);
$data = curl_exec($s);
curl_close($s);
// Now parse the response into PHP arrays using parser code in an external
file
require “JSON.php”;
$parser = new Services_JSON(SERVICES_JSON_LOOSE_TYPE);
$response = $parser->decode($data);
// This is the array of albums we want
$albums = $response[“result”][“album”];
// Display the albums, one to a line
foreach ($albums as $album)
echo $album . “<br>”
?>

### System Architecture

The inventive database is a sea of knowledge organized as a graph, i.e. a set of nodes and a set of links or relationships between those nodes. A schema in the invention is the collection of properties, where each type has one schema. Globally, there is a graph that comprises objects and schema contains the main properties of such objects. Properties are a particular link type, and thus provide a way to refer to a link type specifically. Properties have expected types. For example, if there is an object and the object is a person and the person has a place of birth, then the place of birth property has at the other end an expected type. In other words, the thing that is expected to be at the other end is of a certain type. In the case of place and birth, it would be a city or a place. This provides a form of type enforcement in the user interface where, for example, when a user is typing in place of birth, the system starts auto completing, and constrains the user input to a particular type. For example, auto-completion may apply when an expected type of property is known, such that an input for a user query is constrained to an exact type match. Thus, if the user is querying about the type “film,” then only films would be queried for the user, and only films would be used to complete the user input as the user types a query. Further, a list of relevance ranked terms are provided to the user, which terms are constrained to the type associated with the user query. Thus, the query “new” would result in a user query list that begins with the term “New York,” depending upon type and other constraints. The user selects the desired query from the list to complete the query input. Alternatively, auto-completion involves an enumeration of constrained choices, e.g. a predetermined, fixed size list of possibilities. For example, a gender based type would be constrained to either of “male” or “female” type, and the user could choose between the listed options.

In a further embodiment, /type/type/extends provides a mechanism for annotating an included type. For example, an actor is likely also a person. It can therefore be said that /people/person is an included type of /film/actor. During an auto-completion operation in connection with this example, a search is not only performed for actors, but for people as well.

In this embodiment, it is important to have only one expected type because it improves the usability of the user interface. Thus, every type has a plurality of properties, and the properties themselves have an expected type. Thus, the thing called /type/property itself has properties, and a user can ask the system to show them to him. It is possible enumerate each individual property and its meaning, such that the system is self-describing to some degree.

Expected types, i.e. reversibility of all links, refers to the fact that most properties have reciprocal properties. Thus, the properties have the ability to know what the other property is. One of the is the so-called master property, where one link is to the master property, i.e. the slave link, and the other one of the two links is the master. Because of the reversibility of all links, it does not matter which direction a user looking at.

In the preferred embodiment, everything is an object, but only some things are topics. In an exemplary database, i.e. freebase, everything is a topic. A topic is a pragmatic thing. The platform does not know that a topic is anything different than a person or an actor, it is just another type. In freebase, topics are important because the type that is given to everything is a searchable user concept. Topics can have aliases, which means a topic has more than one name. The notion of type “/type” is core to the platform. A topic is not a /type. However, /type is the core set of things upon which everything else is built.

The following discussion concerns key features of the system architecture, and explains how types and properties tame this vast graph of knowledge by defining a manageable object-oriented view of it.

### The Object Model

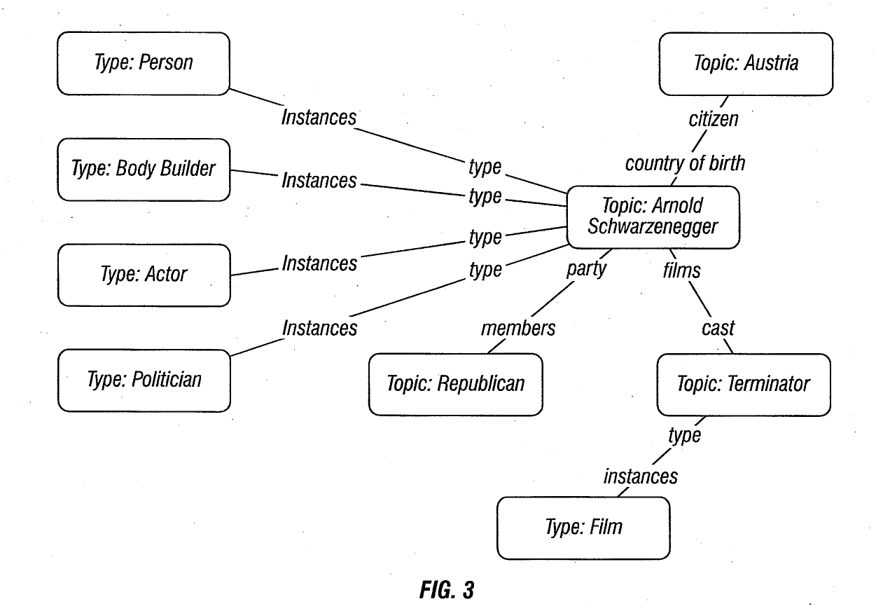

FIG. 3 is a schematic diagram showing nodes and relationships according to the invention. This portion of the graph organizes knowledge about something named Arnold. It tells us that Arnold is a Person, Politician, Body Builder, and Actor. It tells us that Arnold's country of birth is Austria, his political party is Republican, and that he acted in something named Terminator, which is an instance of something known as a Film. The relationships in the graph are bi-directional, so FIG. 3 also tells us, for example, that Austria has Arnold as a citizen, the Republican Party has Arnold as a member, and that Terminator has Arnold as a cast member. Note that this is an example only. An Arnold Schwarzenegger node does exist in the present embodiment of the inventive database, but it may nor may not have the particular relationships pictured here. This nodes-and-relationships representation of knowledge is ideal for searching algorithms, but is not ideal for human understanding. We quickly become lost in the maze of links. To make the database more understandable to humans, the invention allows us to view the graph through an object-oriented lens. Rather than thinking about nodes and their relationships to other nodes, this object-oriented view lets us think about objects and their properties as follows:
Arnold
   sex: male
   birth date: 1947 Jul. 30
   country of birth: Austria
   political party: Republican
   film: Conan the Barbarian
   film: Terminator
   film: Kindergarten Cop
   elected office: Governor of California

In this view, Arnold is an object with a set of properties. Each property has a name and a value. What is missing from the view is any kind of typing. In many object-oriented systems, each property of an object has a known type, and the value of that property must be a member of that type. Look back at FIG. 3 again, and consider the relationships labeled type and instances. Arnold is an instance of Person, Actor, and Politician. Person, Actor, and Politician are types. They are nodes in the graph, but they also impose an object-oriented structure on the graph. Each type defines a set of properties that its instances are expected to have. Each property has a name and a type. An object in the inventive database, therefore, is a node in the graph, plus the type that it should be viewed as, e.g.:

| | |
|---|---|
| Arnold as Person | Arnold as Politician |
| Sex: male | Elected Office office: Governor of CA |
| Date birth date: 1947-July-30 | |
| Country birthplace: Austria | |

Next, consider Arnold as an Actor. Notice that the list of properties above included three properties named film. This is perfectly fine for a nodes-and-relationships model, but it does not fit an object-oriented model where we expect each property to have a single value. A type according to the invention may specify whether each of its properties must be unique or not. For the Actor type, we need a non-unique property named film. The type of this property is a set of films that Arnold has acted in, e.g.:
Arnold as Actor
   Set of Film: [Conan the Barbarian, Kindergarten Cop, Terminator]

Note that the film property is an unordered set of values, not an ordered list of values. If you wanted to display this set of films to an end user, you would most likely want to arrange them into alphabetical order, or by release date. You can ask Metaweb to order them for you, or you can sort them yourself. Some sets, such as the set of tracks on an album have an implicit order, and you can ask Metaweb to return the members of the set in this order. We'll see how to do this in Chapter 3.

### Common Object Properties

All objects, regardless of their type or types, define the following properties:

name This property is a set of human-readable names for the object, suitable for display to the end users of the system. Each name is a /type/text value which holds a string and defines the human language in which it is written. The name property is special in two ways:
An object may have more than one name, but may only have one name per language. That is, it can have only one English name, only one French name, and so on.
When querying the database, a user treats the name property as if it was a single /type/text value rather than a set of values. The invention automatically returns the object's name, if it has one, in the language of choice.

key This property is a set of fully-qualified names for the object. These fully-qualified names are intended for use by developers and scripts and are not typically displayed to end users. Each member of the set is a /type/key value that specifies a namespace object and a name within the namespace. The system guarantees that no two objects ever have the same fully-qualified name.

guid Every object in the inventive database has a globally unique identifier or guid. The guid property specifies the unique identifier for an object. A guid is a long string of hexadecimal digits following the hash character and, in one embodiment, is as follows: #0801010a40005e838000000000019bd2. No two objects ever have the same value of the guid property. This property is read-only.

id The id property is a unique name for the object. For most objects, this property has the same values as the guid property. If an object has a key property that defines a fully-qualified name, then that fully-qualified name is used as the id instead. This is common for objects that are instances of core types, such as the type /type/text or the language /lang/en. As with guid, the id property is unique, i.e. no two objects ever have the same value for this property. This property is read-only. One may not set the id property directly, but its value may change if one sets the key property.

type This property is the set of types associated with the object. The object can be viewed as an instance of any of these types. Each type is itself an object of /type/type.

timestamp This read-only property is a single value of /type/datetime that specifies when the object was created.

creator This read-only property is a single link to a /type/user object that specifies which user created the object.

permission This read-only property is a single link to a /type/permission object. A permission object specifies which user groups are allowed to alter the object.

### Names, Keys, and Ids

Notice that four of the eight common properties described above have to do with names and identifiers for objects. It is important to understand the difference between human-readable names, fully-qualified names, and guids. The inventive database contains an object that represents the human language English. The name property of this object specifies its human-readable name: English. Objects can have only a single name in each language. An English object might have names Anglais and Ingles in French and Spanish, respectively. It is important to understand that the human-readable name of an object does not uniquely identify it. There may be many other objects with the name English”. Because the name property allows only one name in each language, one cannot use it to specify nicknames for an object. One cannot, for example, give the English object the name “American English” in addition to “English.”

As discussed below, most objects that are intended for display to end-users are instances of a type called /common/topic. This type defines a property named alias, which one can use to specify any number of nicknames for an object. The key property of the English object is completely different than the name property. It specifies that the object has the name “en” in a particular namespace object. That namespace object has a key property of its own, which specifies that it has the name “lang” in a special root namespace object. The invention uses the slash character to delimit names, so the English object has the fully-qualified name “/lang/en”. Fully-qualified names are intended for developers and are often used in code, so there are usually written in code font as: /lang/en.

A critical aspect of fully-qualified names is that they are unique. The invention ensures that no two objects ever have the same fully-qualified name at the same time. Human-readable names and fully-qualified names are optional. Objects are not required to have either. But every object does have a guid value that identifies it uniquely. A unique guid is assigned to an object when it is created, and it never changes. It is always possible to identify an object uniquely by specifying the value of its guid property. The guid of the /lang/en object is “#9202a8c04000641f8000000000000092.” Guids and fully-qualified names are both unique identifiers for objects. The id property is flexible and allows one to use either. If one wants to refer to the English object, he could specify an id property of “#9202a8c04000641f80000b0000000092” or “/lang/en.”

### Topics

Objects that are displayed to users of metaweb.com are referred to as topics. These are regular objects that are members of the type /common/topic in addition to any of their other, more-specific types. /common/topic defines properties that allow descriptions, nicknames, documents, and images to be associated with an object, and the metaweb.com client uses these properties to assemble an informative Web page that describes the object or topic.

All topics in the system are also objects. But not all objects are topics. The distinction is that topics are entries that might be of interest to end users. Objects that are not topics are typically part of the system infrastructure, and may be of interest to developers but not end users. Types, properties, domains, and namespaces are not topics, but albums, movies, and restaurants are.

### Values

As with many object-oriented programming languages, that of the invention draws a distinction between objects, i.e. arbitrary collections of properties, and values, i.e. single primitives such as numbers, dates and strings. The invention defines nine value types. As with all types, value types are identified by type objects. Each type object has a fully-qualified name such as /type/int, which is for the value type that represents integer values.

Values have a dual nature in the invention. Depending on how one asks about them, they may behave as primitives, or as simple objects. If one queries a value as if it were an object, then it behaves as a simple object with two properties. As discussed below, two of the value types actually include a third property as well, i.e.:

value this property holds the primitive value
type this property refers to the type object that specifies the type of the value.

If one queries a value as a primitive, then just the value of the value property is returned. The various value types are described below. Notice that value types are in the /type domain, and that their names fall under the /type namespace. Namespaces are discussed in greater detail below.

/type/int

Values of this type are signed integers. The preferred embodiment of the invention uses a 64-bit representation internally, which means that the range of valid values of /type/int is from −9223372036854775808 to 9223372036854775807. An integer literal is an optional minus sign followed by a sequence of decimal digits. The presently preferred embodiment of the invention does not support octal or hexadecimal notation for integers, nor does it allow the use of exponential notation for expressing integers, although other embodiments could support such notation.

/type/float

Values of this type are signed numbers that may include an integer part, a fractional part, and an order of magnitude, i.e. a power of ten by which the integer and fractional parts are multiplied. The invention uses the 64-bit IEEE-754 floating point representation which supports magnitudes between 10-324 and 10308. C and Java programmers may recognize this as the double datatype. The presently preferred embodiment of the invention does not support the special values Infinity and NaN, however. A literal of /type/float consists of an optional minus sign, and optional integer part, and optional decimal point and fractional part and an optional exponent. The integer and fractional parts are strings of decimal digits. The exponent begins with the letter e or E, followed by an optional minus sign, and one to three digits. The following are all valid /type/float literals:

| | |
|---|---|
| 1.0 | # integer and fractional part |
| 1 | # integer part alone |
| .0 | # fractional part alone |
| −1 | # minus sign allowed as first character |
| 1E−5 | # exponent: 1 × 10−5 or 0.00001 |
| 5.98e24 | # weight of earth in kg: 5.98 × 1024 |

There are an infinite number of real numbers, and a 64-bit representation can only describe a finite subset of them. Any number with twelve or fewer significant digits can be stored and retrieved exactly with no loss of precision. Numbers with more than twelve significant digits may have those digits truncated when they are stored in the inventive database.

/type/boolean

There are only two values for this type. They represent the Boolean truth values true and false. Note that the invention sometimes uses the absence of a value, i.e. null, in place of false.

/type/id

Values of this type are object identifiers, either guids or fully-qualified names. The object properties guid and id have values of this type.

/type/text

An instance of /type/text is a string of text plus a value that specifies the human language of that text. The name property of an object is a set of values of this type.

/type/text is unusual. Its value property specifies the text itself, but it also has a lang property that specifies the language in which the text is written. The lang property refers to an object of type /type/lang. The /lang namespace holds many instances of this type, such as /lang/en for English. /type/lang and the /lang namespace are discussed in greater detail below. The text of a /type/text value must be a string of Unicode characters, encoded using the UTF-8 encoding. The encoded string must not occupy more than 4096 bytes. Longer chunks of text, or binary data, can be stored in the database in the form of a /type/content object, which is described later.

/type/key

Instances of /type/key represent a fully-qualified name. The key property of an object is a set of /type/key values. The value property of a /type/key value is the local, or unqualified part of a fully-qualified name. As with /type/text, /type/key has a third property. The namespace property of a key refers to the /type/namespace object that qualifies the local name. The namespace property and the value property combine to produce a fully-qualified name.

As an example, consider the object that represents the value type /type/int. The key property of this object has a value of “int,” and a namespace that refers to the /type namespace. The /type namespace is also an object, and its key property has a value of type and a namespace that refers to the root namespace object. The value property of a key must be a string of ASCII characters, and may include letters, numbers, underscores, hyphens, and dollar signs. A key may not begin or end with a hyphen or underscore. The dollar sign is special. It must be followed by four hexadecimal digits, using letters A through F, in uppercase, and is used when it is necessary to map Unicode characters into ASCII so that they can be represented in a key. To represent an extended Unicode character that does not fit in four hexadecimal digits, encode that character in UTF-16 using a surrogate pair, and then express the surrogate pair using two dollar-sign escapes. Keys used as names for domains, types and properties are further restricted. They may not include hyphens or dollar signs, and may not include two underscores in a row.

/type/rawstring

A value of /type/rawstring is a string of bytes with no associated language specification. The length of the string must not exceed 4096 bytes. Use /type/rawstring instead of /type/text for small amounts of binary data and for textual strings that are not intended to be human readable.

/type/uri

An instance of /type/uri represents a URI (Uniform Resource Identifier: see RFC 3986). The value property holds the URI text, which should consist entirely of ASCII characters. Any non-ASCII characters, and any characters that are not allowed in URIs should be URI-encoded using hexadecimal escapes of the form % XX to represent arbitrary bytes.

/type/datetime

An instance of /type/datetime represents an instant in time. That instant may be as long as a year or as short as a fraction of a second. The value property is a string representation of a date and time formatted according to a subset of the ISO 8601 standard. /type/datetime only supports dates specified using month and day of month. It does not support the ISO 8601 day-of-year, week-of-year and day-of-week representations. A /type/datetime value that represents the first millisecond of the 21st century is as follows: 2001-01-01 00:00:00.001Z. Notice the following points about this format:
Longer intervals of time (years, months, etc.) are specified before shorter intervals (minutes, seconds, etc.).
Years must be specified with a full four digits, even when the leading digits are zeros. Negative years are allowed, but years with more than four digits are not allowed.
Months and days must always be specified with two digits, starting with 01, even when the first digit is a 0.
The components of a date are separated from each other with hyphens.
A date is separated from the time that follows with a space.
Times are specified using a 24-hour clock. Midnight is hour 00, not hour 24. Hours and minutes must be specified with two digits, even when the first digit is 0.
Seconds must be specified with two digits, but may also include a decimal point and a fractional second. The database allows up to nine digits after the decimal point.
The hours, minutes, and seconds components of a time specification are separated from each other with colons.
A time may be followed by a time zone specification. The capital letter Z is special. It specifies that the time is in Universal Time, or UTC (formerly known as GMT). Local time zones that are later than UTC. i.e. East of the Greenwich meridian, are expressed as a positive offset of hours and minutes such as +05:30 for India. Local times earlier than UTC are expressed with a negative offset, such as −08:00 for US Pacific time. If no time zone is specified, then the /type/datetime value is assumed to be a local time in an unknown time zone. Specifying a time zone of +00:00 is the same as specifying Z. Specifying −00:00 is the same as omitting the time zone altogether.
All characters used in the /type/datetime representation are from the ASCII character set, so date and time values can be treated as strings of 8-bit ASCII characters.

A /type/datetime value can represent time at various granularities, and any of the date or time fields on the right-hand side can be omitted to produce a value with a larger granularity. For example, the seconds field can be omitted to specify a day, hour, and minute. Or all the time fields and the day-of-month field can be omitted to specify just a year and a month. Also, the date fields can be omitted to specify a time that is independent of date. A time zone may not be appended to a date alone. There must be at least an hour field specified before a time zone. The following are example /type/datetime values that demonstrate the allowed formats:

| | |
|---|---|
| 2001 | # The year 2001 |
| 2001-01 | # January 2001 |
| 2001-01-01 | # January 1st 2001 |
| 2001-01-01 01Z | # 1 hour past midnight (UTC), January 1st |
| | 2001 |
| 2000-12-31 23:59Z | # 1 minute before midnight (UTC) December |
| | 31st, 2000 |
| 2000-12-31 23:59:59Z | # 1 second before midnight (UTC) December |
| | 31st, 2000 |
| 2000-12-31 23:59:59.9Z | # .1 second before midnight (UTC) December |
| | 31st, 2000 |
| 00:00:00Z | # Midnight, UTC |
| 12:15 | # Quarter past noon, local time |
| 17-05:00 | # Happy hour, Boston (US Eastern Standard |
| | Time) |

### Types

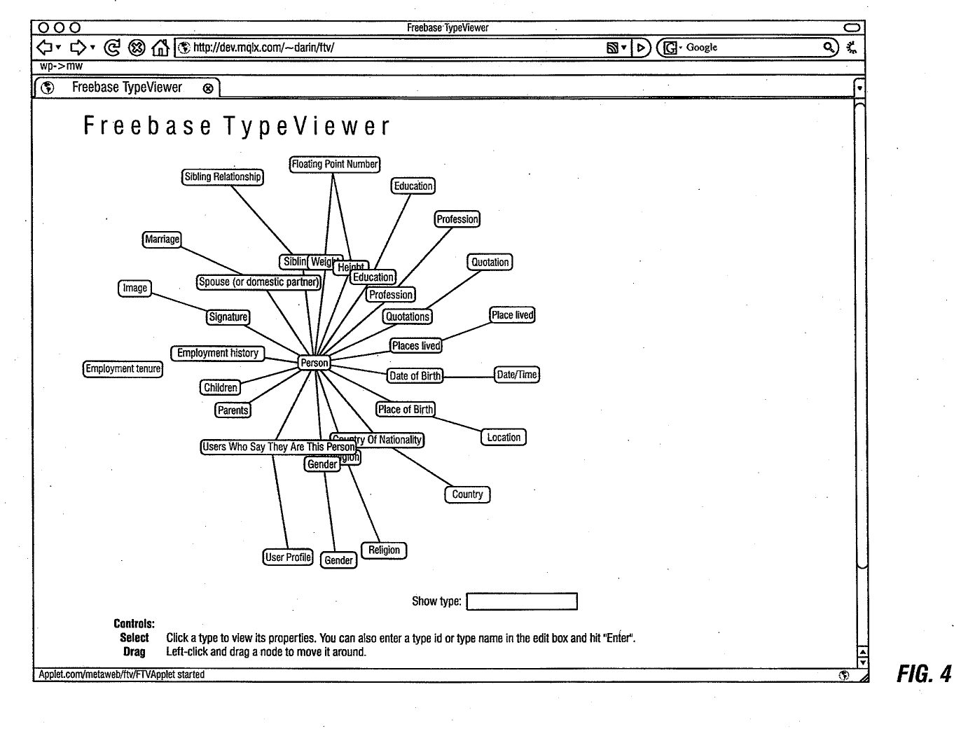

Types that are not value types are object types. The invention pre-defines a number of object types that are organized into domains of related types. Users are allowed and encouraged to define new object types as needed. Pre-defined object types can be categorized into the core types that are part of the system infrastructure, common types that are used commonly throughout the system, and domain-specific types, such as the music-related types /music/artist, /music/album and /music/track. The core types are all part of the /type domain which they share with the value types, and the common types are all part of the /common domain. FIG. 4 is a tree diagram showing categories of types according to the invention.

The following discussion introduces important core and common types. It is not necessary to understand these types in detail to make productive use of the invention. Still, knowing what these basic types are is a helpful orientation to the system.

### Core Types

Types, properties, domains, and namespaces are fundamental to the invention's architecture, but are represented by ordinary types. These most fundamental types are described below.

/type/object

As discussed above, all objects share a set of common properties: name, id, key, and so on. These universal object properties are defined by a core type named /type/object. If one is an object-oriented programmer familiar with languages such as Java, one might guess that /type/object is the root of the type hierarchy, and that it is the super class of all other object types. In fact, however, the invention does not have a type hierarchy. Types do not have super types. /type/object is not a normal type. Objects are never declared to be instances of this type. Remember that one of the common object properties is type. It specifies a set of types for the object.

/type/object never needs to be a member of this set. In fact, an object's set of types can be empty, and the object still has all of the common properties. The /type/object type exists as a convenient placeholder. It serves to group the /type/property objects that represent the common object properties.

/type/type

This type describes a type, which means that it is the only type that is an instance of itself.

Types have five properties:

properties The set of properties defined by the type.

instance The set of instances of the type. For commonly used properties, this set may obviously grow quite large. Recall, however that all relationship between objects in the database are inherently bi-directional. Because every object has a type property that refers to its type, it follows that every type has a set of incoming links from its instances. Thus, every type automatically maintains a set of its instances.

domain The domain to which the type belongs.

expected_by The set of properties whose value is of the type.

default_property The name of the default property for the type. When one asks the inventive database to return an object as if it were a primitive value, the value of the default property is returned for that type. For value types, the default property is value. For most object types the default property is name. And for core types in the /type domain, the default property is id.

/type/property

Every type defines a set of properties for its instances. The members of this set are /type/property objects. The common name and key properties of a property object specify the human-readable and fully-qualified names for the property. In addition, properties specific to /type/property specify, e.g.:
The expected type of the value of the property
Whether the property is unique. A unique property may only have a single value, or may have no value). A property that is not unique has a set of zero or more values.
The reciprocal property, if there is one.
The type of which this property is a part.

The notion of a reciprocal property deserves more explanation. Recall that all links in the database are bi-directional. This means that any time a property of type A refers to an object of type B. The invention automatically has a link from that object of type B back to the originating object of type A. Type B can take advantage of this bi-directionality and include a property that links back to objects of type A. As a concrete example, consider the properties property of /type/type. It specifies the set of properties for a type. Its reciprocal is the schema property of /type/property, which specifies the type object or schema of which the property is a part.

/type/domain

A domain represents a set of related types, and also serves as a namespace for those types. For access control purposes, each domain object refers to one or more user group objects that own the domain. Only members of the specified user groups are allowed to add new types to the domain or to edit types within the domain.

/type/namespace

This type represents a namespace, and is used by the value type /type/key. It defines the keys property which is a set of /type/key values that specify the names in the namespace.

### Content Types

The following types from the /type and /common domains are important content-related types:

/type/content

Large chunks of content, such as HTML documents and graphical images, are not stored in regular nodes. Instead, these large objects, sometimes called lobs, are kept in a separate store. A /type/content object is the bridge between the object database and the content store. A /type/content object represents an entry in the content store, and the guid of the /type/content object is used as an index for retrieving the content. In addition to providing access to the content store, /type/content defines important properties. The media_type property specifies the MIME type of the content. For textual content, the text_encoding and language properties specify the encoding and language of the text. The length property specifies the size in bytes of the content. The source property refers to a /type/content_import object that specifies the source of the content.

/type/content_import

This type describes the source of imported content. Its properties include the URI or filename from which the content was obtained, the user who imported the content, and a timestamp that specifies when the content was imported.

/type/media_type

Instances of this type represent a MIME media type such as “text/html” or “image/png”. Instances are given fully-qualified names within the /media_type namespace, and can be specified with ids such as /media_type/text/html or /media_type/image/png.

/type/text_encoding

Instances of this type represent standard text encodings, such as ASCII and Unicode UTF-8. Instances are given fully-qualified names within the /media_type/text_encoding namespace, and can be specified with ids such as /media_type/text_encoding/ascii. Type/text is special. In most systems, a text is a string with text in it, and if it were internationalized, that string would be in a format such as UTF 8, which is the standard for international codes. In the invention, there is a difference between a text and a raw string. A raw string is a string. A type text is a triple where the left-hand side of the triple is the language, such as the English language. For example, the name Arnold Schwarzenegger is an assertion in the database that Arnold Schwarzenegger has a name in the English language called Arnold Schwarzenegger. He might have a similar assertion, for example, in Japanese or in German.

/type/lang

This type represents a human language. It is used by /type/content objects and also by /type/text values. Pre-defined instances of this type are given fully-qualified names within the /lang namespace, and can be specified with ids like /lang/en and /lang/fr.

/common/topic

As described above, objects that are intended for display to end users are called topics. Such objects typically have some appropriate domain-specific type, such as /music/artist or /food/restaurant, but are also instances of the type /common/topic. This type defines properties that allow documents and images to be associated with the topic. Another property allows a set of URLs to be associated with the topic. Also, because objects can only have a single name in any given language, /common/topic has an alias property that allows any number of nicknames to be specified for the topic.

/common/document

This type represents a document of some sort. /common/topic uses this type to associate documents with topics. The most important property is content, which specifies the single /type/content object that refers to the document content. Other properties of /common/document provide meta-information about the document, such as authors, publication date, and so on.

/common/image

/type/content objects that represent images are typically co-typed with this type. /common/image defines a size property that specifies the pixel dimensions of the image.

### Access Control Types

The following types are part of the access control framework:

/type/user

Each registered user is represented with an object of /type/user. User objects have fully-qualified names in the /user namespace. If a username is joe_developer, then the user's /type/user object is /user/joe_developer.

/type/usergroup

This type represents a set of users.

/type/permission

This type is the key to access control. Its properties specify the set of objects that require this permission for modifications, and also the set of user groups that have the permission.

### Domains

A domain is an object of /type/domain. It represents a collection of related types. A number of types, from the /type and /common domains, have already been described herein. The invention pre-defines types in a number of general domains. The set of domains is expected to grow, but at the time of this writing, it includes:

/business
/food
/measurement_unit
/education
/language
/music
/film
/location

As can be seen from the names of these domains, domain objects are also instances of /type/namespace, and the types contained by domains are members of both the domain and the namespace. Every user who registers for an account has their own domain. If a user's username is fred, then his domain is /user/fred/default_domain. When one uses the metaweb.com client to define a new type named Beer, it is given the id /user/fred/default_domain/beer. If a user's type becomes an important and commonly used one, it may be promoted by system administrators to a top-level domain. In this case, the type might be given a new fully-qualified name, such as /zymurgy/beer.

### Namespaces

In the invention, namespaces provide a user with the ability to build a name, such as /film/actor. The names are built using links in the graph. For example, there is a node called /, a node called actor, and a node called film, that are linked together with assertions. The link is called key and the link type is, itself, a property. There is the concept of a namespace, and / is a type of namespace. Thus, this aspect of the invention provides for creating a / namespace out of nodes and links. Namespaces are useful because one can refer to a name space, for example, such as /film/actor whereas in the prior art one referred to a name, such as Arnold Schwarzenegger.

Namespaces are a critical part of the system infrastructure because they allow us to refer to important objects, such as types, with simple mnemonic names rather than opaque guids. It would be very inconvenient to query the database if we had to write “#9202a8c04000641f8000000000000565” instead of “/common/topic,” for example. A number of important namespaces, including /type, /user, /lang, and /media_type, have already been described herein. In addition to these, each domain and user object is also a namespace. Also, there is the root namespace, whose id is simply /. A number of important namespaces are populated with pre-defined objects using names defined by international standards. The languages in the /lang namespace use language codes, such as “en” for English and “fr” for French, defined by ISO 639. The media types in /media_type are defined by IANA and listed at http://www.iana.org/assignments/media-types/. And the text encodings in /media_type/text_encoding use names defined by IANA at http://www.iana.org/assignments/character-sets.

### Access Control

A further aspect of the invention concerns the access control system, which is deeply related to the link type system. The access control system is the invention's permission system, and is intended to prevent a user from doing certain kinds of writing. In the presently preferred embodiment of the invention, it is not concerned preventing one from reading, although reading could be restricted as well. The permission system can prevent the from putting a link in, when a user wants to add a link to connect two things together, based on something that is known about the user. Thus, every node in the system requires write permission. In the invention such permission is another node that indicates who is allowed to write.

Thus, the system is completely open for reading. Anyone who can connect to the system's servers can read data from them. When adding or editing data, however, access control comes into play. We've already seen that the types /type/user, /type/usergroup, and /type/permission are used for access control. One embodiment of the invention provides an access control model that is quite simple. Every object has a permission property that refers to a /type/permission object. The permission object specifies a set of user groups whose members have permission to modify the object. If a user is a member of one or more of the specified groups, then that user can edit the object. Otherwise, the user is not allowed to. This simple access control model is, by default, also very open. To allow and encourage free collaboration most objects have a permission object that gives edit permission to all users. If a user, Fred, creates a new object in the database, his friend Jill can freely edit that object. Any other user can edit the object as well, and there is no way for Fred to restrict the permission on his object.

A primary exception to this open access control model is type objects. Having a stable type system is very important to the success of the system. Each domain has a usergroup associated with it, and only members of that usergroup can create new types in the domain or alter existing types in the domain. Each user account has an associated domain. Fred's domain is /user/fred/default_domain. This domain has an associated usergroup. Initially, Fred is the only member of this group. He is allowed to add to the usergroup, and if he adds his friend Jill, then she is permitted to create new types in Fred's domain. Other key parts of the invention infrastructure also have restrictive access control, of course. Ordinary users are not allowed to insert objects into the /lang namespace or the /type domain, for example.

### EXAMPLE

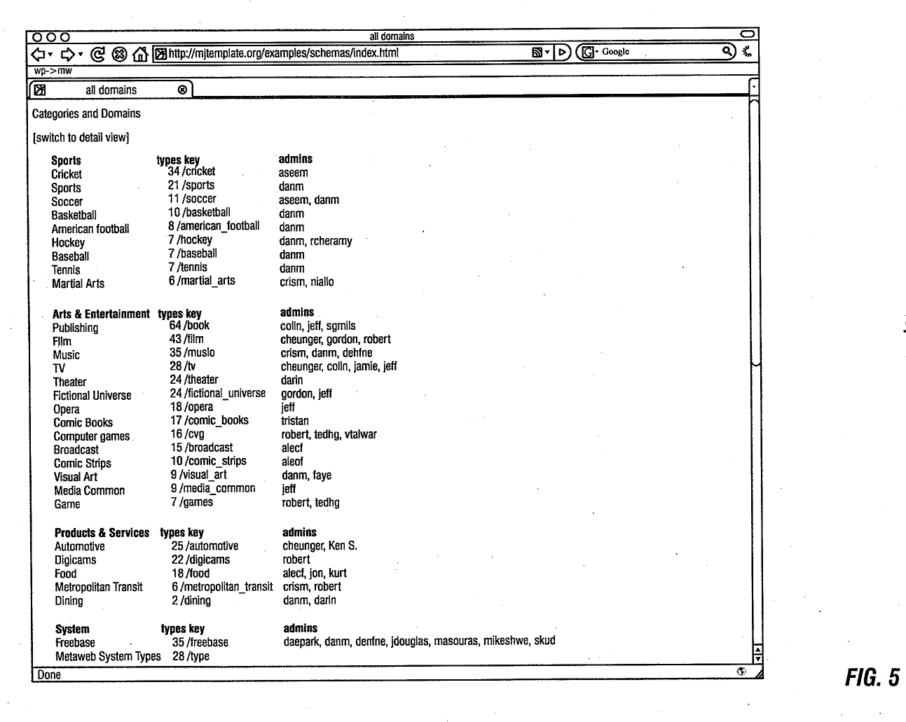

FIGS. 5-8 provide examples of the inventive database from a user perspective.

FIG. 5 is a screen shot showing types for all domains according to the invention. In FIG. 5, a list of public types is presented. Users may add topics. Further, a private list of types (not shown), for example for an enterprise, may be provided as well. The invention provides a database the does not require a formal schema in the sense of a traditional database. Thus, the type system provide by the invention is open and users may add types as desired.

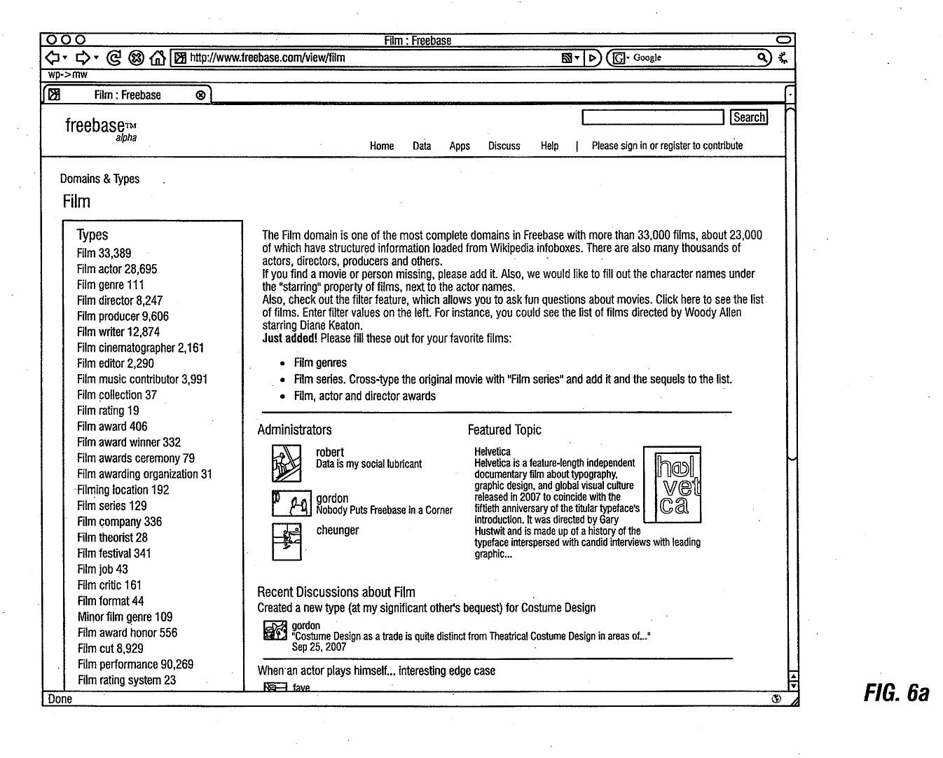

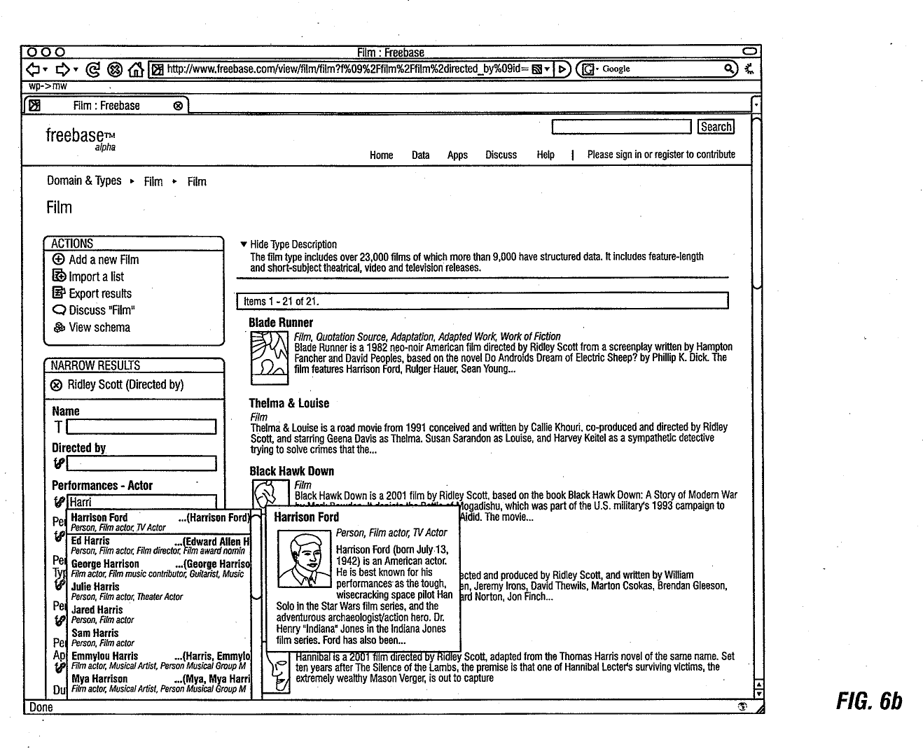

FIG. 6a is a screen shot showing a film filter for types according to the invention. In FIG. 6, the user has selected the type “film.” The user has also set filters for the director, i.e. Ridley Scott, and the starring actor, i.e. Harrison ford (FIG. 6b). The view returned to the user shows a list of movies that were directed by Ridley Scott and those that also star Harrison ford.

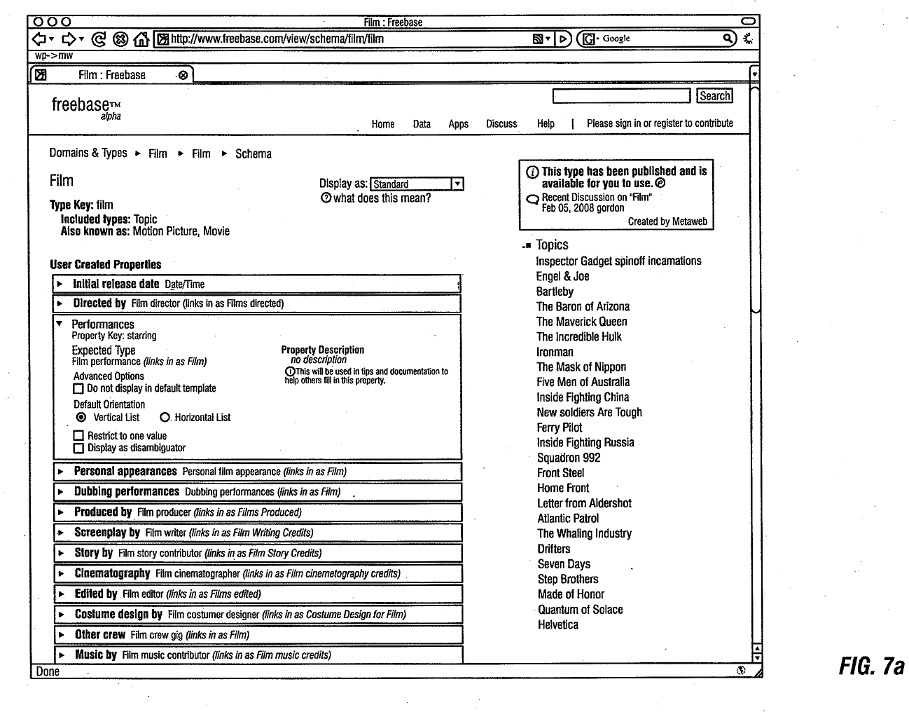

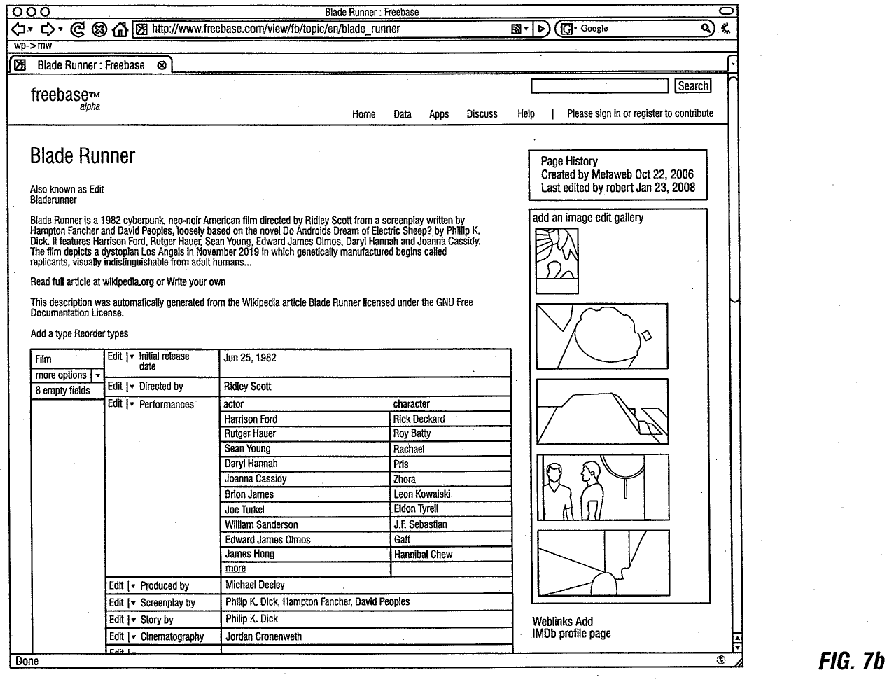

FIG. 7a is a screen shot showing user created properties for a film filter type according to the invention. In FIG. 7a, the filter for the type “film” includes, as an example, many parameters 70. Because the invention allows the community of users to create types that are then instantly available via the query API, schema building is not a separate activity from data entry. Existing relationships in the display graph continue to function as schemas are expanded (FIG. 7b).

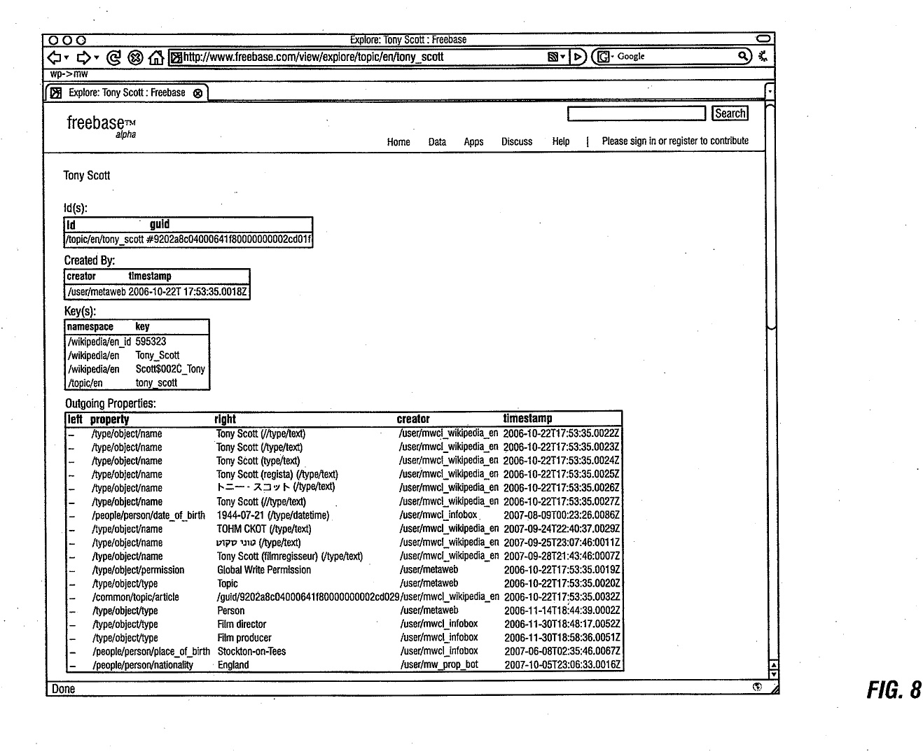

FIG. 8 is a screen shot showing an explore view for the user created properties for a film filter type of FIG. 7, according to the invention.

### Partially Ordered Collections

A further aspect of the invention concerns ordered and partially ordered collections. For example, suppose a user wanted to put the tracks on a CD in order. There is a CD that has several tracks on it and the tracks are actually ordered on the CD. To order the tracks in a prior art system, such as RDF, one actually has to order them explicitly. To avoid this, the invention provides a mechanism by which a user makes entries and gives them indices.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1-19. (canceled)

20. A scalable graph database, comprising:
a type system created by interaction of users with the graph database and stored in the graph database itself;
a namespace model built on said type system, wherein names are resolved against a dataset rather than being pre-declared;
a dynamically generated, user contributed, accretive database schema;
wherein data entry via means operable by a community of users creates types in said type system that are then instantly available via a query API, said query API further comprising a tree-based object/property query language;
wherein graph database queries are informed by said dynamically generated schema;
wherein schema building is collaborative and not a separate activity from data entry; and
wherein existing relationships in said graph database continue to function as said schema is expanded; and
a database store, wherein objects in said database store comprise versioned primitives that are attributed to a graph database contributor;
wherein relationships between said primitives are implicitly bi-directional
wherein said graph database contains attributes and relationships between topics; and
wherein topics can be multiply typed and properties are optional.

21. The database of claim 20, further comprising:
an access control and permissions model built on said graph database via data structures in the graph database related to properties, user groups, and groups of users;
wherein permissions are readily devolved to groups of database contributors.

22. The database of claim 20, said query API further comprising:
a plurality of query trees which are expanded to yield query results;
wherein a hierarchical query representing a graph constraint sent to the graph database receives a reply having a similarly shaped tree containing query results.

23. The database of claim 20, said query API further comprising:
an API for writing to said graph database comprising a tree based model.

24. The database of claim 20, said query API further comprising:
a query language that supports explicitly ordering items, sorting result sets, optional constraint clauses, and highly nested queries.

25. The database of claim 20, wherein said query API is based on the JSON open standard data interchange syntax.

26. A database, comprising:
a graph comprising a plurality of objects comprising arbitrary collections of properties, said objects further comprising a set of nodes and a set of reversible links expressing relationships between said nodes; and
a schema comprising a collection of properties of said objects, said properties comprising an expected type, wherein every type comprises a plurality of properties, wherein each property has an expected type, and wherein each type has one schema.

27. The database of claim 26, wherein said expected type further comprises a type enforcement scheme in a user interface wherein user input invokes an auto completion module that constrains said user input to a particular type.

28. The database of claim 27, said auto completion module comprising:
means for relevance ranking a list of candidate terms for presentation to a user during auto completion of a user query.

29. The database of claim 27, said auto completion module comprising:
means for enumerating user input to constrain a user query to a fixed list of predetermined terms.

30. The database of claim 27, said auto completion module comprising:
means for annotating an included type.

31. The database of claim 26, wherein all objects, regardless of their type or types, define at least one of the following properties:
a name property comprising a set of human-readable names for an object, suitable for display to end users of database;
wherein said name property comprises a value that holds a string and that defines a human language in which it is written; wherein an object may have more than one name, but may only have one name per language; and
wherein if when querying the database, a user treats the name property as if it was a single value rather than a set of values, the database automatically returns the object's name, if it has one, in a language of choice;
a key property comprising a set of fully-qualified names for an object;
wherein each member of the set is a value that specifies a namespace object and a name within the namespace; and
wherein no two objects ever have the same fully-qualified name;
a guid property for every object in the database comprising a globally unique identifier that specifies a unique identifier for an object;
wherein no two objects ever have the same value of the guid property;
an id property comprising a unique name for an object;
wherein no two objects ever have the same value of the id property.
This property is read-only;
a type property comprising a set of types associated with an object;
wherein an object can be viewed as an instance of any of said types; and
wherein each type is itself an object type;
a timestamp property comprising a single value that specifies when an object was created;
a creator property comprising a single link to an object that specifies which user created the object; and
a permission property comprising a single link to a permission object which specifies which user groups are allowed to alter an object.

32. The database of claim 26, further comprising:
a plurality of topics comprising objects that are displayed to users.

33. The database of claim 26, further comprising:
a plurality of values comprising single primitives or simple objects, said values comprising:
a value property that holds the primitive value; and
a type property comprising a type object that specifies a type of the value.

34. The database of claim 26, further comprising:
a plurality of namespaces that provide a user with the ability to build a name using nodes and links in the graph.

35. The database of claim 26, further comprising:
an access control system for controlling user ability to modify an object;
wherein every object has a permission property that refers to a permission object which specifies a set of user groups whose members have permission to modify the object.

36. A method for creating a scalable graph database, comprising the steps of:
providing a type system created by interaction of users with the graph database and stored in the graph database itself;
providing a namespace model built on said type system, wherein names are resolved against a dataset rather than being pre-declared;
providing a dynamically generated, user contributed, accretive database schema;
wherein data entry via means operable by a community of users creates types in said type system that are then instantly available via a query API, said query API further comprising a tree-based object/property query language;
wherein graph database queries are informed by said dynamically generated schema;
wherein schema building is collaborative and not a separate activity from data entry; and
wherein existing relationships in said graph database continue to function as said schema is expanded; and
providing a database store, wherein objects in said database store comprise versioned primitives that are attributed to a graph database contributor;
wherein relationships between said primitives are implicitly bi-directional;
wherein said graph database contains attributes and relationships between topics; and
wherein topics can be multiply typed and properties are optional.

37. The method of claim 36, further comprising the step of:
providing an access control and permissions model built on said graph database via data structures in the graph database related to properties, user groups, and groups of users;
wherein permissions are readily devolved to groups of database contributors.

38. A method for creating a database, comprising the steps of:
providing a graph comprising a plurality of objects comprising arbitrary collections of properties, said objects further comprising a set of nodes and a set of reversible links expressing relationships between said nodes; and
providing a schema comprising a collection of properties of said objects, said properties comprising an expected type, wherein every type comprises a plurality of properties, wherein each property has an expected type, and wherein each type has one schema.
